(19) United States
(12) Patent Application Publication
(10) Pub. No.: US 2026/0042669 A1
(43) Pub. Date: Feb. 12, 2026

(54) PURIFYING PHOSPHORUS HALIDE COMPOUNDS

(71) Applicant: ENTEGRIS, INC., Billerica, MA (US)

(72) Inventors: Paolo Moreschini, Newtown, CT (US); Joseph R. Despres, Middletown, CT (US); Kaitlin J. Lawrence, Brookfield, CT (US)

(21) Appl. No.: 19/296,730

(22) Filed: Aug. 11, 2025

Related U.S. Application Data
(60) Provisional application No. 63/682,294, filed on Aug. 12, 2024.

(51) Int. Cl. C01B 25/10; C09K 13/00

(52) U.S. Cl. CPC C01B 25/10; C09K 13/00; C01P 2006/80

(57) ABSTRACT

This disclosure provides a vessel and methods for handling high-purity phosphorus fluoride compounds. The vessel can include a phosphorus fluoride component including a phosphorus fluoride compound with a purity of at least 99.9%, as measured by gas chromatography and/or infrared spectroscopy. Also disclosed is a method which includes obtaining a solid component containing a metal fluorophosphate compound and water, heating the solid component to remove water, and further heating to form a phosphorus fluoride compound with a purity of at least 99.9%, as measured by gas chromatography and/or infrared spectroscopy.

### CROSS-REFERENCE TO RELATED APPLICATION

This application claims the benefit of and priority to U.S. Provisional Application No. 63/682,294, filed Aug. 12, 2024, the entirety of which is incorporated herein for all purposes.

### FIELD

This disclosure relates to the purification of phosphorus halide compounds. More specifically, it concerns methods and systems for removing impurities from phosphorus fluoride components to achieve high purity levels, suitable for applications like etching in semiconductor manufacturing.

### BACKGROUND

Phosphorus halide compounds, particularly phosphorus fluoride compounds, are utilized in various applications, including semiconductor manufacturing processes such as etching. These compounds are often employed to create fine features in silicon substrates and other materials. The effectiveness of phosphorus halide compounds in these applications is dependent on their composition and characteristics. Analytical techniques like gas chromatography and Fourier-transform infrared spectroscopy (FTIR) are commonly used to assess the purity and quality of these compounds. Vessels and specialized packaging are used for storing and delivering phosphorus halide compounds.

### SUMMARY

This disclosure relates to the purification of phosphorus halide compounds, particularly phosphorus fluoride components, for applications such as etching.

Various embodiments, as described herein, include vessels for containing a phosphorus fluoride component, where the component comprises a phosphorus fluoride compound with a purity of at least 99.9%, as measured by gas chromatography and/or FTIR spectroscopy. The vessel may comprise a body defining an interior volume, with the body having an inner and outer surface. A coating may cover at least a portion of the inner surface.

Other embodiments relate to methods for synthesizing a phosphorus fluoride compound. The method may include obtaining a solid component comprising a metal fluorophosphate compound and water, then heating the solid component at a first temperature to remove water, followed by heating to a second, higher temperature to form a reaction product comprising a phosphorus fluoride compound.

Further embodiments pertain to methods for removing at least one impurity from a phosphorus fluoride component. This may involve flowing the phosphorus fluoride component over a sorbent to remove at least a portion of the impurity and then recovering a purified phosphorus fluoride component.

The preceding summary is provided to facilitate an understanding of some of the innovative features unique to the present disclosure and is not intended to be a full description. A full appreciation of the disclosure can be gained by taking the entire specification, claims, drawings, and abstract as a whole.

### BRIEF DESCRIPTION OF THE DRAWINGS

The disclosure may be more completely understood in consideration of the following description of various illustrative embodiments in connection with the accompanying drawings, in which:

FIG. 1 is a schematic diagram of a phosphorus fluoride component vessel, according to some embodiments;

FIG. 2 is a flowchart of a method for synthesizing a phosphorus fluoride compound, according to some embodiments; and

FIG. 3 is a flowchart of a method for removing at least one impurity from a phosphorus fluoride component, according to some embodiments.

While the disclosure is amenable to various modifications and alternative forms, specifics thereof have been shown by way of example in the drawings and will be described in detail. It should be understood, however, that the intention is not to limit aspects of the disclosure to the particular illustrative embodiments described. On the contrary, the intention is to cover all modifications, equivalents, and alternatives falling within the spirit and scope of the disclosure.

### DETAILED DESCRIPTION

As used in this specification and the appended claims, the singular forms “a”, “an”, and “the” include plural referents unless the content clearly dictates otherwise. As used in this specification and the appended claims, the term “or” is generally employed in its sense including “and/or” unless the content clearly dictates otherwise.

The following detailed description should be read with reference to the drawings in which similar elements in different drawings are numbered the same. The detailed description and the drawings, which are not necessarily to scale, depict illustrative embodiments and are not intended to limit the scope of the invention. The illustrative embodiments depicted are intended only as exemplary. Selected features of any illustrative embodiment may be incorporated into an additional embodiment unless clearly stated to the contrary.

Some embodiments, described herein, relate to phosphorus halide compounds for etching applications, including, for example and without limitation, cryogenic etch applications. The phosphorus halide compounds may be useful for etching deep channels, trenches, etc., with high aspect ratios, in silicon substrates, among others. The phosphorus halide compounds have improved purity levels (e.g., low to undetectable levels of impurities), overcoming challenges associated with conventional phosphorus fluorides that, due to the presence of impurities have low etch rates and have negative impact on the vessel containing the compounds. In some embodiments, some impurities, such as metal impurities, can be volatilized and deposited in the channel or trench to be etched, reducing quality and performance of the resulting device.

At least one challenge associated with reducing the presence of impurities in phosphorus halide compounds, such as, for example and without limitation, phosphorus fluoride compounds, is the numerous opportunities for impurities to be formed or otherwise present, from synthesis, storage, and delivery. For example, in some embodiments, a system and a method for synthesizing a phosphorus halide compound is provided in which any moisture or water present in reagent materials is removed to reduce or eliminate the presence of impurities that result from reactions between the water and the reagent. In some embodiments, a system and a method for removing impurities from a phosphorus fluoride component is provided before the phosphorus fluoride component is loaded into a vessel or other packaging. The phosphorus fluoride components may be present from the synthesis of the phosphorus halide compound according to the methods disclosed herein. In some embodiments, at least a portion of the impurities are removed via a sorbent. In some embodiments, a system and a method for removing moisture or water from within the vessel is provided. To facilitate the removal and/or release of moisture or water, a coating with is applied to the vessel walls.

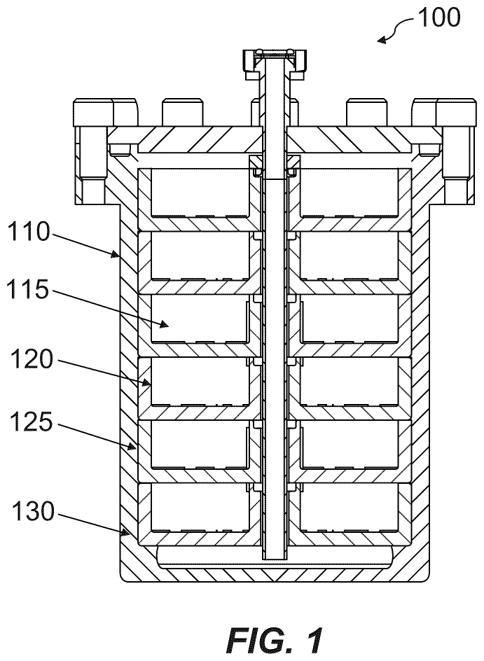

FIG. 1 is a schematic diagram of a phosphorus fluoride component vessel 100, according to some embodiments. As shown in FIG. 1, the phosphorus fluoride component vessel 100 includes a vessel body 110 that defines an interior volume 115. The vessel body 110 has an inner surface 120 and an outer surface 125. A coating 130 may cover all or at least a portion of the inner surface 120. A phosphorus fluoride component is located in the interior volume 115 of the vessel body 110. The phosphorus fluoride component may have low levels of impurities and/or contaminants.

According to various embodiments, the phosphorus fluoride component may comprise a phosphorus halide compound. For example, in some embodiments, the phosphorus fluoride component comprises a phosphorus fluoride compound. The phosphorus fluoride compound can include at least one of a phosphorus trifluoride (PF₃), a phosphorus pentafluoride (PF₅), or any combination thereof.

When present in the vessel body 110, the phosphorus fluoride component can be contained in the phosphorus fluoride component vessel 100 under conditions sufficient to have a purity of at least 95% as measured by gas chromatography and/or Fourier-transform infrared spectroscopy (FTIR). For example, in some embodiments, the phosphorus fluoride component has a purity of at least 95% to 99.9995%, or any range or subrange between 95% and 99.9995%. In some embodiments, the phosphorus fluoride compound has a purity of 95% to 99.9995%, 95% to 99.999%, 95% to 99.99%, 95% to 99.9%, 95% to 99.5%, 95% to 99%, 95% to 98%, 95% to 97%, 95% to 96%, 96% to 99.9995%, 97% to 99.9995%, 98% to 99.9995%, 99% to 99.9995%, 99.9% to 99.9995%, 99.5% to 99.9995%, 99.99% to 99.9995%, or 99.999% to 99.9995%.

The conditions under which the phosphorus fluoride component is contained in the phosphorus fluoride component vessel 100 can include at least one of a temperature, a pressure, or any combination thereof.

The temperature of the phosphorus fluoride component within the vessel 100 is maintained at a temperature ranging from −2° C. to 50° C., or any range or subrange between −2° C. and 50° C. For example, in some embodiments, the temperature of the vessel ranges from 0° C. to 45° C., 5° C. to 40° C., 10° C. to 35° C., 15° C. to 30° C., or 20° C. to 25° C. In some embodiments, the temperature of the vessel ranges from 0° C. to 50° C., 5° C. to 50° C., 10° C. to 50° C., 15° C. to 50° C., 20° C. to 50° C., 25° C. to 50° C., 30° C. to 50° C., 35° C. to 50° C., 40° C. to 50° C., or 45° C. to 50° C. In some embodiments, the temperature of the vessel ranges from −2° C. to 45° C., −2° C. to 40° C., −2° C. to 35° C., −2° C. to 30° C., −2° C. to 25° C., −2° C. to 20° C., −2° C. to 15° C., −2° C. to 10° C., −2° C. to 5° C., −2° C. to 0° C.

The pressure within the vessel 100 (e.g., a pressure at which the phosphorus fluoride component is stored) may be sub-atmospheric, atmospheric, or super-atmospheric. For example, the pressure within the vessel may be a pressure of 50 Torr to 700 Torr, or any range or subrange between 50 Torr and 700 Torr. For example, in some embodiments, the pressure within the vessel is a pressure of 100 Torr to 650 Torr, 150 Torr to 600 Torr, 200 Torr to 550 Torr, 250 Torr to 500 Torr, 300 Torr to 450 Torr, or 350 Torr to 400 Torr. In some embodiments, the pressure within the vessel is a pressure of 100 Torr to 700 Torr, 150 Torr to 700 Torr, 200 Torr to 700 Torr, 250 Torr to 700 Torr, 300 Torr to 700 Torr, 350 Torr to 700 Torr, 400 Torr to 700 Torr, 450 Torr to 700 Torr, 500 Torr to 700 Torr, 550 Torr to 700 Torr, 600 Torr to 700 Torr, or 650 Torr to 700 Torr. In some embodiments, the pressure within the vessel is a pressure of 760 Torr to 350,000 Torr, or any range or subrange between 760 Torr and 350,000 Torr. For example, in some embodiments, the pressure within the vessel is a pressure of 760 Torr to 300,000 Torr, 760 Torr to 200,000 Torr, 760 Torr to 100,000 Torr, 760 Torr to 50,000 Torr, 10,000 Torr to 350,000 Torr, 100,000 Torr to 350,000 Torr, 200,000 Torr to 350,000 Torr, or 300,000 Torr to 350,000 Torr.

In some embodiments, the vessel 100 comprises a coating (e.g., coating 130) and stores the phosphorus fluoride compound at a certain purity. In some embodiments, the certain purity is between 99.9% and 99.9995%, as described herein. The coating 130 may comprise at least one of a metal, a fluorinated polymer or a fluoropolymer, or any combination thereof.

In embodiments in which the coating 130 includes a metal, the metal may comprise at least one of an alkali metal, an alkaline earth metal, a transition metal, a post-transition metal, or any combination thereof. In some embodiments, the metal comprises at least one of a zinc, a copper, an iron, a nickel, a tin, a silver, a gold, or any combination thereof.

In embodiments in which the coating 130 includes a fluorinated polymer or fluoropolymer, the fluorinated polymer comprises a homopolymer or a copolymer. In some embodiments, the fluorinated polymer comprises a copolymer of at least one fluoro-olefin monomer and optionally at least one non-fluorinated co-monomer. In some embodiments, the fluorinated polymer may be fluorinated (i.e., partially fluorinated), perfluorinated, or may include non-fluorine halogen atoms, such as, for example and without limitation, chlorine. In some exemplary embodiments, the coating can comprise at least one of polymerized perfluoroalkyl ethylene having a C₁-C₁₀ perfluoroalkyl group, polytetrafluoroethylene (PTFE), tetrafluoroethylene/perfluoro (alkyl vinyl ether) copolymer (PFA), tetrafluoroethylene/hexafluoropropylene copolymer (FEP), tetrafluoroethylene/perfluoro (alkyl alkenyl ether)/hexafluoropropylene copolymer (EPA), polyhexafluoropropylene, ethylene/tetrafluoroethylene copolymer (ETFE), poly trifluoroethylene, polyvinylidene fluoride (PVDF), polyvinyl fluoride (PVF), polychlorotrifluoroethylene (PCTFE), ethylene/chlorotrifluoroethylene copolymer (ECTFE), or any combination thereof.

The fluorinated polymer or fluoropolymer can present on all vapor-exposed surfaces of the vessel body 110. The vapor exposed surfaces comprise surfaces that are exposed to a reactive fluorine-containing vapor. The reactive fluorine-containing vapor may be used to passivate the inner surfaces of the vessel. In some embodiments, when the coating 130 is exposed to the reactive fluorine-containing vapor, the reactive fluorine-containing vapor reacts with a surface of the coating 130. In some embodiments, when the coating 130 is exposed to the reactive fluorine-containing vapor, the reactive fluorine-containing vapor diffuses through from the surface of the coating 130 to a depth beneath the surface of the coating 130.

The reactive fluorine-containing vapor comprises a molecular fluorine source vapor, which may be derived from a liquid or solid. In some embodiments, the reactive fluorine-containing vapor comprised fluorine. In some embodiments, the reactive fluorine-containing vapor comprises at least one of a fluorinated organic compound, a perfluorinated organic compound, or any combination thereof. In some embodiments, for example, the reactive fluorine-containing vapor comprises at least one of a fluorinated alkane, a perfluorinated alkane, a fluorinated alkene, a perfluorinated alkene, or any combination thereof, wherein any one or more of which may be linear or branched. In some embodiments, the reactive fluorine-containing vapor comprises at least one of CF₄, C₂F₄, C₃F₆, C₄F₈, CHF₃, C₂H₂F₂, C₂F₆, HF, CH₃F, or any combination thereof.

In some embodiments, as described herein, the coating 130 comprises a hydrophobic coating. In some embodiments, the hydrophobicity of the coating may be measured by the contact angle. A hydrophobic coating (such as PTFE) prevents moisture from absorbing and thus reducing the probability of reaction and formation of impurities

In embodiments in which the coating is a hydrophobic coating, the hydrophobicity of the coating can be measured by a contact angle of water on a surface of the coating. In some embodiments, the coating has a surface energy with a water contact angle of at least 80°. For example, in some embodiments, the coating has a water contact angle of 80° to 170°, 80° to 160°, 80° to 150°, 80° to 140°, 80° to 130°, 80° to 120°, 80° to 110°, 80° to 100°, 80° to 90°, 90° to 170°, 100° to 170°, 110° to 170°, 120° to 170°, 130° to 170°, 140° to 170°, 150° to 170°, 160° to 170°, 90° to 170°, 90° to 160°, 90° to 150°, 90° to 140°, 90° to 130°, 90° to 120°, 90° to 110°, or 90° to 100°.

The coating 130, as described herein according to the various embodiments, may cover all or at least a portion of the inner surface 120 of the vessel body 110. In some embodiments, the coating 130 covers 10% to 99% of the inner surface 120 of the vessel body 110, or any range or subrange between 10% and 99%. The coating may cover, for example, 10% to 90%, 10% to 80%, 10% to 70%, 10% to 60%, 10% to 50%, 10% to 40%, 10% to 30%, 10% to 20%, 20% to 99%, 30% to 99%, 40% to 99%, 50% to 99%, 60% to 99%, 70% to 99%, 80% to 99%, or 90% to 99% of the inner surface 120 of the vessel body 110. In some embodiments, the coating 130 covers the entire inner surface 120 of the vessel body 110.

The coating 130, as described herein according to the various embodiments, may have a thickness of 0.01 μm to 10 μm, or any range or subrange between 0.01 μm to 10 μm. In some embodiments, for example, the coating 130 may have a thickness of 0.1 μm to 9 μm, 0.5 μm to 8 μm, 1 μm to 7 μm, 2 μm to 6 μm, or 3 μm to 5 μm. In some embodiments, the coating 130 may have a thickness of 0.01 μm to 9 μm, 0.01 μm to 8 μm, 0.01 μm to 7 μm, 0.01 μm to 6 μm, 0.01 μm to 5 μm, of 0.01 μm to 4 μm, 0.01 μm to 3 μm, 0.01 μm to 2 μm, 0.01 μm to 1 μm, 0.01 μm to 0.5 μm, 0.01 μm to 0.10 μm. In some embodiments, the coating 130 may have a thickness of 0.1 μm to 10 μm, 0.5μ m to 10 μm, 1μ m to 10 μm, 2μ m to 10μ, 3 μm to 10 μm, 4 μm to 10μ, 5 μm to 10 μm, 6 μm to 10 μm, 7 μm to 10 μm, 8 μm to 10 μm, or 9 μm to 10 μm.

When the phosphorus fluoride component contained within vessel 100, as described herein according to various embodiments, is vaporized to form a phosphorus fluoride component vapor and when the phosphorus fluoride component vapor is delivered to a semiconductor tool (e.g., a cryogenic etch system), the phosphorus fluoride component vapor comprises at least 95% by weight of the phosphorus halide compound based on a total weight of the phosphorus fluoride component vapor. For example, in some embodiments, the phosphorus fluoride component vapor comprises 95% to 99.9995% by weight of the phosphorus halide compound based on the total weight of the phosphorus fluoride component vapor, or any range or subrange between 95% and 99.9995%. In some embodiments, for example, the phosphorus fluoride component vapor comprises 95.5% to 99.5%, 96% to 99%, 96.5% to 98.5%, or 97% to 98% by weight of the phosphorus halide compound based on the total weight of the phosphorus fluoride component vapor. In some embodiments, the phosphorus fluoride component vapor comprises 95% to 99.5%, 95% to 99%, 95% to 98.5%, 95% to 98%, 95% to 97.5%, 95% to 96.5%, 95% to 96.0000%, 95% to 95.5000% by weight of the phosphorus halide compound based on the total weight of the phosphorus fluoride component vapor. In some embodiments, the phosphorus fluoride component vapor comprises 95.5% and 99.9995%, 96% and 99.9995%, 96.5% and 99.9995%, 97% and 99.9995%, 97.5% and 99.9995%, 98% and 99.9995%, 98.5% and 99.9995%, 99% and 99.9995%, or 99.5% and 99.9995% by weight of the phosphorus halide compound based on the total weight of the phosphorus fluoride component vapor.

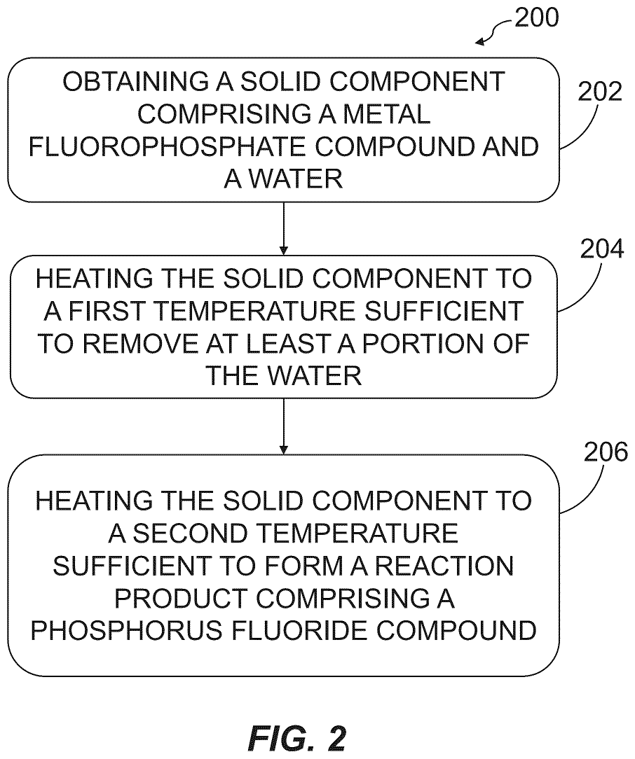

FIG. 2 is a flowchart of a method for synthesizing a phosphorus fluoride compound, according to some embodiments. As shown in FIG. 2, in some embodiments, the method for synthesizing a phosphorus fluoride compound comprises one or more of the following steps: obtaining 202 a solid component comprising a metal fluorophosphate compound and a water; heating 204 the solid component to a first temperature sufficient to remove at least a portion of the water; and heating 206 the solid component to a second temperature sufficient to form a reaction product comprising a phosphorus fluoride compound.

At step 202, the method for synthesizing the phosphorus fluoride compound comprises obtaining a solid component comprising a metal fluorophosphate compound and a water. The solid component may be provided in the form of a powder, a pellet, a granule, a bead, a brick, a block, a sheet, a rod, a plate, a film, a coating, or a particle. The metal fluorophosphate compound may comprise at least one of LiPF₆, NaPF₆, KPF₆, RbPF₆, CsPF₆, or any combination thereof.

At step 204, the method for synthesizing the phosphorus fluoride compound comprises heating the solid component to a first temperature sufficient to remove at least a portion of the water.

In some embodiments, the heating is conducted by conduction, convection, or radiation. In some embodiments, the heating, at the first temperature, is conducted while mixing the solid component. In some embodiments, the heating, at the first temperature, is conducted in the presence of an inert gas.

The first temperature may be a temperature sufficient to remove (e.g., vaporize) water and/or moisture present, without causing a reaction to occur in which the solid component, such as, the metal fluorophosphate compound, to decompose into the reaction product, and/or without causing the water to react with the metal fluorophosphate compound. In some embodiments, the first temperature may be a temperature of 20° C. to 70° C., or any range or subrange between 20° C. and 70° C. For example, in some embodiments, the first temperature may be a temperature of 25° C. to 65° C., 30° C. to 60° C., 35° C. to 55° C., or 40° C. to 50° C. In some embodiments, the first temperature may be a temperature of 25° C. to 70° C., 30° C. to 70° C., 35° C. to 70° C., 40° C. to 70° C., 45° C. to 70° C., 50° C. to 70° C., 55° C. to 70° C., 60° C. to 70° C., or 65° C. to 70° C. In some embodiments, the first temperature may be a temperature of 20° C. to 65° C., 20° C. to 60° C., 20° C. to 55° C., 20° C. to 50° C., 20° C. to 45° C., 20° C. to 40° C., 20° C. to 35° C., 20° C. to 30° C., or 20° C. to 25° C. In some embodiments, the first temperature is less than a decomposition temperature of the metal fluorophosphate compound. In some embodiments, the first temperature is less than a temperature at which the water reacts with the metal fluorophosphate compound.

At step 206, the method for synthesizing the phosphorus fluoride compound comprises heating the solid component to a second temperature sufficient to form a reaction product comprising a phosphorus fluoride compound.

In some embodiments, the heating is conducted by conduction, convection, or radiation.

The second temperature may be a temperature sufficient to cause a reaction to occur in which the solid component, such as the metal fluorophosphate compound, to decompose into the reaction product. With all or at least a portion of the water removed (e.g., purged from a reaction vessel, etc.), the formation of impurities and/or contaminants is minimized or avoided. The second temperature may be a temperature of 70° C. to 500° C., or any range or subrange between 70° C. and 500° C. For example, in some embodiments, the second temperature may be a temperature of 80° C. to 190° C., 90° C. to 180° C., 100° C. to 170° C., 110° C. to 160° C., 120° C. to 150° C., or 130° C. to 140° C. In some embodiments, the second temperature may be a temperature of 80° C. to 500° C., 90° C. to 500° C., 100° C. to 500° C., 110° C. to 500° C., 120° C. to 500° C., 130° C. to 500° C., 140° C. to 500° C., 150° C. to 500° C., 160° C. to 500° C., 170° C. to 500° C., 180° C. to 500° C., 190° C. to 500° C., 200° C. to 500° C., 225° C. to 500° C., 250° C. to 500° C., 275° C. to 500° C., 300° C. to 500° C., 325° C. to 500° C., 350° C. to 500° C., 375° C. to 500° C., 400° C. to 500° C., 425° C. to 500° C., 450° C. to 500° C., or 475° C. to 500° C. The second temperature may be greater than the first temperature. In some embodiments, the second temperature is a temperature equal to or greater than a decomposition temperature of the metal fluorophosphate compound.

The reaction product may comprise a purified phosphorus fluoride compound. For example, in some embodiments, the phosphorus fluoride compound has a purity of at least 99.9% as measured by gas chromatography and/or FTIR spectroscopy. In some embodiments, the phosphorus fluoride compound has a purity ranging from 95% to 99.9995%, or any range or subrange between 95% and 99.9995% as measured by gas chromatography and/or FTIR spectroscopy. In some embodiments, for example, the phosphorus fluoride compound has a purity ranging from 95.5% to 99.5%, 96% to 99%, 96.5% to 98.5%, or 97% to 98% as measured by gas chromatography and/or FTIR spectroscopy. In some embodiments, the phosphorus fluoride compound has a purity ranging from 95% to 99.5%, 95% to 99%, 95% to 98.5%, 95% to 98%, 95% to 97.5%, 95% to 97%, 95% to 96.5%, 95% to 96%, 95% to 95.5% as measured by gas chromatography and/or FTIR spectroscopy. In some embodiments, the phosphorus fluoride compound has a purity ranging from 95.5% and 99.9995%, 96% and 99.9995%, 96.5% and 99.9995%, 97% and 99.9995%, 97.5% and 99.9995%, 98% and 99.9995%, 98.5% and 99.9995%, 99% and 99.9995%, or 99.5% and 99.9995% as measured by gas chromatography and/or FTIR spectroscopy. In some embodiments, the purity of the phosphorus fluoride compound may vary with the duration of exposure, conditions of exposure, among other factors.

In some embodiments, the reaction product further comprises at least one impurity. The impurity may comprise a substance other than the phosphorus fluoride compound. For example, in some embodiments, the reaction product comprises at least one of HF, POF₃, HPOₓF_{y}, a metal impurity, a chlorine impurity, an oxygen impurity, or any combination thereof. In some embodiments, at least one impurity comprises a reaction product of the phosphorus fluoride compound and water. In some embodiments, at least one impurity comprises a reaction product of the metal fluorophosphate compound and a water. In some embodiments, at least one impurity is present in at least one of a vapor phase, a gas phase, a solid phase, a liquid phase, or any combination thereof.

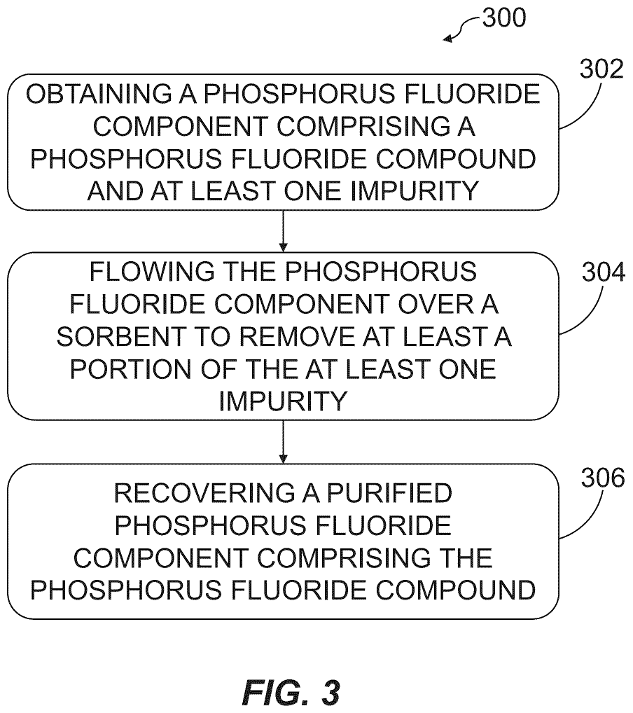

FIG. 3 is a flowchart of a method for removing at least one impurity from a phosphorus fluoride component, according to some embodiments. As shown in FIG. 3, in some embodiments, the method for removing at least one impurity from a phosphorus fluoride component may comprise one or more of the following steps: obtaining 302 a phosphorus fluoride component comprising a phosphorus fluoride compound and at least one impurity; flowing 304 the phosphorus fluoride component over a sorbent to remove at least a portion of the at least one impurity; recovering 306 a purified phosphorus fluoride component comprising the phosphorus fluoride compound.

At step 302, in some embodiments, the method for removing at least one impurity from a phosphorus fluoride component comprises obtaining a phosphorus fluoride component comprising a phosphorus fluoride compound and at least one impurity. In some embodiments, the phosphorus fluoride component is the reaction product from the method of FIG. 2. For example, in some embodiments, the phosphorus fluoride compound comprises at least one of a phosphorus trifluoride (PF₃), a phosphorus pentafluoride (PF₅), or any combination thereof. In some embodiments, at least one impurity comprises at least one of HF, POF₃, a metal impurity, a chlorine impurity, an oxygen impurity, or any combination thereof.

At step 304, in some embodiments, the method for removing at least one impurity from a phosphorus fluoride component comprises flowing the phosphorus fluoride component over a sorbent to remove at least a portion of the at least one impurity.

In some embodiments, the flowing comprises contacting the phosphorus fluoride component with the sorbent to remove at least a portion of the at least one impurity. In some embodiments, the contacting comprises bringing the phosphorus fluoride component and the sorbent into close or immediate proximity to remove at least a portion of the at least one impurity. In some embodiments, the contacting comprises bringing the phosphorus fluoride component and sorbent into direct physical contact to remove at least a portion of the at least one impurity. In some embodiments, the contacting comprises adding the phosphorus fluoride component to the sorbent to remove at least a portion of the at least one impurity. In some embodiments, the contacting comprises agitating the phosphorus fluoride component and the sorbent to remove at least a portion of the at least one impurity. In some embodiments, the contacting proceeds under conditions sufficient to remove at least at least a portion of the at least one impurity to recover a purified phosphorus fluoride component described herein.

In some embodiments, the contacting comprises displacing at least a portion of at least one impurity. In some embodiments, the contacting comprises disassociating at least a portion of at least one impurity. In some embodiments, the contacting comprises extracting at least a portion of the at least one impurity. In some embodiments, the contacting comprises releasing at least a portion of at least one impurity.

In some embodiments, the temperature of the sorbent is maintained at a temperature of 50° C. to 150° C., or any range or subrange therebetween. In some embodiments, the temperature of the sorbent is maintained at 50° C. to 140° C., 50° C. to 130° C., 50° C. to 120° C., 50° C. to 110° C., 50° C. to 100° C., 50° C. to 90° C., 50° C. to 80° C., 50° C. to 70° C., 50° C. to 60° C., 60° C. to 150° C., 70° C. to 150° C., 80° C. to 150° C., 90° C. to 150° C., 100° C. to 150° C., 110° C. to 150° C., 120° C. to 150° C., 130° C. to 150° C., or 140° C. to 150° C.

In some embodiments, the sorbent is operated under pressure. In some embodiments, the pressure within the sorbent is a pressure of 1 torr to 760 torr. In some embodiments, the pressure within the sorbent is a pressure of 20 torr to 760 torr, 40 torr to 760 torr, 60 torr to 760 torr, 80 torr to 760 torr, 100 torr to 760 torr, 120 torr to 760 torr, 140 torr to 760 torr, 160 torr to 760 torr, 180 torr to 760 torr, 200 torr to 760 torr, 220 torr to 760 torr, 240 torr to 760 torr, 260 torr to 760 torr, 280 torr to 760 torr, 300 torr to 760 torr, 320 torr to 760 torr, 340 torr to 760 torr, 360 torr to 760 torr, 380 torr to 760 torr, 400 torr to 760 torr, 420 torr to 760 torr, 440 torr to 760 torr, 460 torr to 760 torr, 480 torr to 760 torr, 500 torr to 760 torr, 520 torr to 760 torr, 540 torr to 760 torr, 560 torr to 760 torr, 580 torr to 760 torr, 600 torr to 760 torr, 620 torr to 760 torr, 640 torr to 760 torr, 660 torr to 760 torr, 680 torr to 760 torr, 700 torr to 760 torr, 720 torr to 760 torr, or 740 torr to 760 torr. In some embodiments, the pressure within the sorbent is a pressure of 20 torr to 740 torr, 20 torr to 720 torr, 20 torr to 700 torr, 20 torr to 680 torr, 20 torr to 660 torr, 20 torr to 640 torr, 20 torr to 620 torr, 20 torr to 600 torr, 20 torr to 580 torr, 20 torr to 560 torr, 20 torr to 540 torr, 20 torr to 520 torr, 20 torr to 500 torr, 20 torr to 480 torr, 20 torr to 460 torr, 20 torr to 440 torr, 20 torr to 420 torr, 20 torr to 400 torr, 20 torr to 380 torr, 20 torr to 360 torr, 20 torr to 340 torr, 20 torr to 320 torr, 20 torr to 300 torr, 20 torr to 280 torr, 20 torr to 260 torr, 20 torr to 240 torr, 20 torr to 220 torr, 20 torr to 200 torr, 20 torr to 180 torr, 20 torr to 160 torr, 20 torr to 140 torr, 20 torr to 120 torr, 20 torr to 100 torr, 20 torr to 80 torr, 20 torr to 60 torr, or 20 torr to 40 torr.

The sorbent may comprise at least one of an adsorbent, an absorbent, or any combination thereof. In some embodiments, the sorbent comprises a metal fluoride component located on a surface of a solid porous support. The metal fluoride component may sorb the at least one impurity from the phosphorus fluoride component. That is, for example, in some embodiments, the metal fluoride component may preferentially or selectively sorb (e.g., adsorb, absorb, etc.) the at least one impurity relative to the phosphorus fluoride compound. In some embodiments, the sorbent comprises a metal fluoride adsorbent.

In some embodiments, the metal fluoride component comprises a metal fluoride compound. In some embodiments, the metal fluoride component comprises at least one of Li, Na, K, Rb, Cs, or any combination thereof. In some embodiments, the metal fluoride component comprises at least one of LiF, NaF, KF, RbPF₆, CsF, or any combination thereof.

In some embodiments, the solid porous support comprises at least one of a zeolite, metal-organic framework (MOF), a porous organic polymer (POP), or any combination thereof. In some embodiments, the solid porous support comprises at least one of a covalent organic framework (COF), hydrogen-bonded organic framework (HOF), or any combination thereof.

In some embodiments, the solid porous support comprises a metal-organic framework. Metal-organic-framework (MOF) adsorbent materials exhibit various physical and molecular forms. Metal-organic frameworks are organic-inorganic hybrid crystalline porous materials that have molecular structures that include a regular repeating array of positively charged metal ions surrounded by organic “linker” molecules. The metal ions form nodes that bind the arms of the organic linker molecules together to form a repeating, hollow cage-like structure. Metal organic frameworks (MOFs) are nanoporous materials consisting of organic linkers coordinated to metal ions in crystalline structures.

In some embodiments, the metal-organic framework comprises at least one of a zeolitic imidazolate frameworks (ZIF), a Carboxylate-based MOF, a Zirconium-based MOF, or any combination thereof.

Zeolitic imidazolate frameworks (ZIF) comprise metal (mainly tetrahedral Zn2) bridged by the nitrogen atoms of imidazolate linkers. Zeolitic imidazolate frameworks (ZIF) includes a tetrahedrally-coordinated transition metal such as iron (Fe), cobalt (Co), Copper (Cu), or Zinc (Zn), connected by imidazolate linkers, which may be the same or different within a particular ZIF composition or relative to a single transition metal atom of a ZIF structure. The ZIF structure includes four-coordinated transition metals linked through imidazolate units to produce extended frameworks based on tetrahedral topologies. ZIFs are said to form structural topologies that are equivalent to those found in zeolites and other inorganic microporous oxide materials.

A zeolitic imidazolate framework can be characterized by features that include the type of transition metal (e.g., iron, cobalt, copper, or zinc), the chemistry of the linker (e.g., chemical substituents of the imidazolate units), pore size of the ZIF, surface area of the ZIF, pore volume of the ZIF, among other physical and chemical properties. Dozens (at least 105) of unique ZIF species or structures are known, each having a different chemical structure based on the type of transition metal and the type of linker (or linkers) that make up the framework. Each topology is identified using a unique ZIF designation, e.g., ZIF-1 through ZIF-105. For a description of ZIFs, including particular chemical compositions and related properties of a large number of known ZIF species, see Phan et al., “Synthesis, Structure, and Carbon Dioxide Capture Properties of Zeolitic Imidazolate Frameworks,” Accounts of Chemical Research, 2010, 43 (1), pp 58-67 (Received Apr. 6, 2009).

In some embodiments, the solid porous support comprises a porous organic polymer (POP). Porous organic polymer (POP) material is a class of organic frameworks of light elements (C, H, B, O, N) interconnected by covalent bonds with low framework density, sustained porosity, and high thermo-chemical stability.

In some embodiments, the solid porous support comprises a covalent organic framework.

In some embodiments, the solid porous support comprises a hydrogen-bonded organic framework.

At step 306, in some embodiments, the method for removing at least one impurity from a phosphorus fluoride component comprises recovering a purified phosphorus fluoride component comprising the phosphorus fluoride compound.

In some embodiments, the recovering comprises storing the purified phosphorus fluoride component in a vessel. In some embodiments, the vessel is a pressure-regulated vessel. Non-limiting examples of such other vessels include, without limitation, a pressure-regulated vessel including an internal gas pressure regulator, such as, for example, those of a type commercially available from Entegris, Inc. (Billerica, Mass., USA) under the trademark VAC (Vacuum Actuated Cylinder) or trademark SDS (Safe Delivery Source); a pressure-regulated vessel including an internal gas pressure regulator, such as, for example, those of a type as commercially available from Entegris, Inc. (Billerica, Mass., USA) under the trademark VAPOR SORB; other vessels, such as, for example, those of a type commercially available from Entegris, Inc. (Billerica, Mass., USA) under the trademark PRO-EVAP.

In some embodiments, the purified phosphorus fluoride component comprises the phosphorus fluoride compound. In some embodiments, the phosphorus fluoride compound has a purity of at least 99.9% as measured by gas chromatography and/or infrared spectroscopy. In some embodiments, the phosphorus fluoride compound has a purity ranging from 95% to 99.9995%, or any range or subrange between 95% and 99.9995% as measured by gas chromatography and/or FTIR spectroscopy. In some embodiments, for example, the phosphorus fluoride compound has a purity ranging from 95.5% to 99.5%, 96% to 99%, 96.5% to 98.5%, or 97% to 98% as measured by gas chromatography and/or FTIR spectroscopy. In some embodiments, the phosphorus fluoride compound has a purity ranging from 95% to 99.5%, 95% to 99%, 95% to 98.5%, 95% to 98%, 95% to 97.5%, 95% to 97%, 95% to 96.5%, 95% to 96%, 95% to 95.5% as measured by gas chromatography and/or FTIR spectroscopy. In some embodiments, the phosphorus fluoride compound has a purity ranging from 95.5% and 99.9995%, 96% and 99.9995%, 96.5% and 99.9995%, 97% and 99.9995%, 97.5% and 99.9995%, 98% and 99.9995%, 98.5% and 99.9995%, 99% and 99.9995%, or 99.5% and 99.9995% as measured by gas chromatography and/or FTIR spectroscopy.

Some embodiments relate to an etchant. In some embodiments, the etchant comprises a phosphorus halide compound. For example, in some embodiments, the phosphorus fluoride component comprises a phosphorus fluoride compound. In some embodiments, the phosphorus halide compound comprises at least one of a phosphorus trifluoride (PF₃), a phosphorus pentafluoride (PF₅), or any combination thereof.

In some embodiments, the phosphorus halide compound has a purity of at least 99.9% as measured by gas chromatography and/or FTIR spectroscopy. In some embodiments, the phosphorus halide compound has a purity ranging from 95% to 99.9995%, or any range or subrange between 95% and 99.9995% as measured by gas chromatography and/or FTIR spectroscopy. In some embodiments, for example, the phosphorus halide compound has a purity ranging from 95.5% to 99.5%, 96% to 99%, 96.5% to 98.5%, or 97% to 98% as measured by gas chromatography and/or FTIR spectroscopy. In some embodiments, the phosphorus halide compound has a purity ranging from 95% to 99.5%, 95% to 99%, 95% to 98.5%, 95% to 98%, 95% to 97.5%, 95% to 97%, 95% to 96.5%, 95% to 96%, 95% to 95.5% as measured by gas chromatography and/or FTIR spectroscopy. In some embodiments, the phosphorus halide compound has a purity ranging from 95.5% and 99.9995%, 96% and 99.9995%, 96.5% and 99.9995%, 97% and 99.9995%, 97.5% and 99.9995%, 98% and 99.9995%, 98.5% and 99.9995%, 99% and 99.9995%, or 99.5% and 99.9995% as measured by gas chromatography and/or FTIR spectroscopy. In some embodiments, the purity of the phosphorus halide compound may vary with the duration of exposure, conditions of exposure, among other factors.

In some embodiments, the etchant further comprises at least one impurity. The impurity may comprise a substance other than the phosphorus halide compound. For example, in some embodiments, the etchant comprises at least one of HF, POF₃, a metal impurity, a chlorine impurity, an oxygen impurity, or any combination thereof. In some embodiments, at least one impurity comprises a reaction product of the phosphorus halide compound and a water. In some embodiments, at least one impurity is present in at least one of a vapor phase, a gas phase, a solid phase, a liquid phase, or any combination thereof.

In some embodiments, at least one impurity is removed from the etchant under conditions related to the method of FIG. 2. For example, the method comprises heating a solid component to a first temperature sufficient to remove at least a portion of the water; and heating the solid component to a second temperature sufficient to form a reaction product comprising a phosphorus halide compound.

In some embodiments, at least one impurity is removed from the etchant under conditions related to the method of FIG. 3. For example, the method comprises flowing the etchant over a sorbent to remove at least a portion of the at least one impurity. The method comprises recovering a purified etchant comprising the phosphorus halide compound.

Having thus described several illustrative embodiments of the present disclosure, those of skill in the art will readily appreciate that yet other embodiments may be made and used within the scope of the claims hereto attached. Numerous advantages of the disclosure covered by this document have been set forth in the foregoing description. It will be understood, however, that this disclosure is, in many respect, only illustrative. Changes may be made to the details, particularly in matters of shape, size, and arrangement of parts without exceeding the scope of the disclosure. The disclosure's scope is, of course, defined in the language in which the appended claims are expressed.

### Aspects

Various Aspects are described below. It is to be understood that any one or more of the features recited in the following Aspect(s) can be combined with any one or more other Aspect(s).

Aspect 1 is a vessel comprising a phosphorus fluoride component, which itself comprises a phosphorus fluoride compound, wherein the phosphorus fluoride compound is contained in the vessel under conditions sufficient to have a purity of at least 99.9% as measured by gas chromatography and/or FTIR spectroscopy.

Aspect 2 is the vessel according to Aspect 1, wherein the phosphorus fluoride compound has a purity of 99.9% to 99.9995%.

Aspect 3 is the vessel according to any one of Aspects 1-2, wherein the phosphorus fluoride compound comprises at least one of a phosphorus trifluoride (PF₃), a phosphorus pentafluoride (PF₅), or any combination thereof.

Aspect 4 is the vessel according to any one of Aspects 1-3, wherein the vessel comprises a body defining an interior volume, wherein the body has an inner surface and an outer surface, and a coating covering at least a portion of the inner surface of the body, wherein the coating comprises at least one of a metal, a fluorinated polymer, or any combination thereof.

Aspect 5 is the vessel according to any one of Aspects 1-4, wherein the metal comprises at least one of zinc, copper, iron, nickel, tin, silver, gold, and combination thereof.

Aspect 6 is the vessel according to any one of Aspects 1-5, wherein the coating has a water contact angle of at least 80 degrees.

Aspect 7 is the vessel according to any one of Aspects 1-6, wherein the vessel comprises a coating and stores the phosphorus fluoride compound at a certain purity.

Aspect 8 is a method comprising obtaining a solid component comprising a metal fluorophosphate compound and a water, heating the solid component to a first temperature sufficient to remove at least a portion of the water, and heating the solid component to a second temperature sufficient to form a reaction product comprising a phosphorus fluoride compound, wherein the second temperature is greater than the first temperature, and wherein the phosphorus fluoride compound has a purity of at least 99.9% as measured by gas chromatography and/or infrared spectroscopy.

Aspect 9 is the method according to Aspect 8, wherein the metal fluorophosphate compound comprises LiPF₆.

Aspect 10 is the method according to any one of Aspects 8-9, wherein the solid component is provided in the form of a powder.

Aspect 11 is the method according to any one of Aspects 8-10, wherein the first temperature is less than a decomposition temperature of the metal fluorophosphate compound.

Aspect 12 is the method according to any one of Aspects 8-11, wherein the first temperature is less than a temperature at which the water reacts with the metal fluorophosphate compound.

Aspect 13 is the method according to any one of Aspects 8-12, wherein the heating, at the first temperature, is conducted while mixing the solid component.

Aspect 14 is the method according to any one of Aspects 8-13, wherein the heating, at the first temperature, is conducted in the presence of an inert gas.

Aspect 15 is the method according to any one of Aspects 8-14, wherein the second temperature is a temperature equal to or greater than a decomposition temperature of the metal fluorophosphate compound.

Aspect 16 is the method according to any one of Aspects 8-15, wherein the reaction product further comprises at least one impurity, wherein the at least one impurity comprises at least one of HF, POF₃, a metal impurity, a chlorine impurity, an oxygen impurity, or any combination thereof.

Aspect 17 is a method comprising obtaining a phosphorus fluoride component comprising a phosphorus fluoride compound and at least one impurity, flowing the phosphorus fluoride component over a sorbent to remove at least a portion of the at least one impurity, and recovering a purified phosphorus fluoride component comprising the phosphorus fluoride compound, wherein the phosphorus fluoride compound has a purity of at least 99.9% as measured by gas chromatography and/or infrared spectroscopy.

Aspect 18 is the method according to Aspect 17, wherein the sorbent comprises a metal fluoride adsorbent.

Aspect 19 is the method according to claim 17, wherein the sorbent comprises a solid porous support and a metal fluoride compound located on a surface of the solid porous support, wherein the metal fluoride compound adsorbs the at least one impurity from the phosphorus fluoride component.

Aspect 20 is the method according to any one of Aspects 17-19, wherein the solid porous support comprises at least one of a metal organic framework, a porous organic polymer, or any combination thereof.

Aspect 21 is the method according to any one of Aspects 17-20, wherein the metal fluoride compound comprises at least one of Li, Na, K, Rb, Cs, or any combination thereof.

Aspect 22 is a phosphorus fluoride component comprising a phosphorus fluoride compound, wherein, when the phosphorus fluoride compound is contained in a vessel, the phosphorus fluoride compound has a purity of at least 99.9% as measured by gas chromatography and/or FTIR spectroscopy.

Aspect 23 is a vessel comprising a body defining an interior volume, wherein the body has an inner surface and an outer surface, a coating covering at least a portion of the inner surface of the body, and a phosphorus fluoride component contained within the interior volume of the body, wherein the phosphorus fluoride component comprises a phosphorus fluoride compound, wherein the phosphorus fluoride compound has a purity of at least 99.9% as measured by gas chromatography and/or FTIR spectroscopy.

What is claimed is:

1. A vessel comprising:
a phosphorus fluoride component comprising:
a phosphorus fluoride compound,
wherein the phosphorus fluoride compound is contained in the vessel under conditions sufficient to have a purity of at least 99.9% as measured by gas chromatography and/or FTIR spectroscopy.

2. The vessel of claim 1, wherein the phosphorus fluoride compound has a purity of 99.9% to 99.9995%.

3. The vessel of claim 1, wherein the phosphorus fluoride compound comprises at least one of a phosphorus trifluoride (PF₃), a phosphorus pentafluoride (PF₅), or any combination thereof.

4. The vessel of claim 1, wherein the vessel comprises:
a body defining an interior volume,
wherein the body has an inner surface and an outer surface; and
a coating covering at least a portion of the inner surface of the body,
wherein the coating comprises at least one of a metal, a fluorinated polymer, or any combination thereof.

5. The vessel of claim 4, wherein the metal comprises at least one a zinc, a copper, iron, a nickel, a tin, a silver, a gold, and combination thereof.

6. The vessel of claim 4, wherein the coating has a water contact angle of at least 80°.

7. The vessel of claim 4, wherein the coating has a water contact angle of 80° to 150°.

8. The vessel of claim 4, wherein the coating is a hydrophobic coating.

9. A method comprising:
obtaining a solid component comprising a metal fluorophosphate compound and a water;
heating the solid component to a first temperature sufficient to remove at least a portion of the water; and
heating the solid component to a second temperature sufficient to form a reaction product comprising a phosphorus fluoride compound,
wherein the second temperature is greater than the first temperature;
wherein the phosphorus fluoride compound has a purity of at least 99.9% as measured by gas chromatography and/or infrared spectroscopy.

10. The method of claim 9, wherein the metal fluorophosphate compound comprises LiPF₆.

11. The method of claim 9, wherein the solid component is provided in a form of a powder.

12. The method of claim 9, wherein the first temperature is less than a decomposition temperature of the metal fluorophosphate compound.

13. The method of claim 9, wherein the first temperature is less than a temperature at which the water reacts with the metal fluorophosphate compound.

14. The method of claim 9, wherein the heating, at the first temperature, is conducted while mixing the solid component.

15. The method of claim 9, wherein the heating, at the first temperature, is conducted in a presence of an inert gas.

16. The method of claim 9, wherein the second temperature is a temperature equal to or greater than a decomposition temperature of the metal fluorophosphate compound.

17. The method of claim 9, wherein the reaction product further comprises at least one impurity, wherein the at least one impurity comprises at least one of HF, POF₃, a metal impurity, a chlorine impurity, an oxygen impurity, or any combination thereof.
